(19) United States
(12) Patent Application Publication
(10) Pub. No.: US 2009/0020126 A1
(43) Pub. Date: Jan. 22, 2009

(54) Attachment of a bridge band to an oxygen mask

(76) Inventor: Gregory Yuen Fun Lau, Mocksville, NC (US)

Correspondence Address: Chris Reed, 155 Boyce Dr., Mocksville, NC, 27028, US

(21) Appl. No.: 11/879,197

(22) Filed: Jul. 17, 2007

(51) Int. Cl. A62B 18/08

(52) U.S. Cl. 128/207.11

(57) ABSTRACT

The present invention is a method by which a bridge band attaches to an interface used to communicate breathing gases to a user. The bridge band contains two opposing recesses towards each end, which create a neck area. The interface contains openings in the nose area that accepts the recesses of the bridge band. There are two parallel openings on each side of the centerline of the mask. One end of the bridge band is inserted into the first opening and then out of the second opening until the recesses are fully engaged in the openings. Accordingly, the second end is laced through the openings in the same manner on the opposite side of the mask. The openings and recesses are sized appropriately such that they will engage together fully and tightly.

### BACKGROUND OF THE INVENTION

(1) Field of the Invention

The present invention relates to an oxygen mask used to interface a user to an oxygen delivery system. In particular, the present invention secures a bridge band to the nose area of the mask, which aids in securing the mask to a user's face.

(2) Description of the Prior Art

There are certain medical situations in which it is necessary or desirable to deliver a flow of oxygen gas or a mixture of breathing gases to the airway of a patient. Such delivery systems involve the placement of an interface device, which is typically a nasal cannula or mask or tent, on the face of the user. The patient interface device communicates the flow of a gas from the source with the airway of the patient, so that the therapeutic flow of breathing gas can be delivered to the patient's airway.

In a circumstance where a person uses a mask as the interface of this system it is important to be able to secure the mask to the user's face. Also, in some circumstances it is important to create a seal around the nose to prevent oxygen or medication from irritating the eyes. This can be accomplished through the use of head straps or headgear in conjunction with the adjustment of a bridge band. A bridge band, also referred to as a nose bar, is a piece of flexible, but memorable material, often aluminum, which is located on the mask at the area of the nose. Once the mask is fitted on the user, the bridge band can be bent around the user's nose to conform to the shape and curvature of the nose. Because of the memory of the bridge band material the mask will remain that shape, and thus aid in the security and sealing of the mask.

Prior art teaches that a bridge band can be attached to the mask by chemical and mechanical means. However, current methods can oftentimes fail, which results in the bridge band becoming detached from the mask, and thus relinquishing the seal and security.

One example of bridge band attachment is a combination of chemical and mechanical methods. A mask may have two posts located in the nose area set to either side of the center line. The bridge band would then have two holes, slightly larger in diameter than the diameter of the posts. The holes in the bridge band would slide over the posts, so that the position of the bridge band would be fixed. A cap with a diameter larger than the holes in the bridge band would be glued to each of the posts, concentrically. Mechanically, the bridge band would be secured to the mask by the caps that are chemically bonded to the posts.

Another example is solely mechanical, but similar to the first example. In this example the cap and post would be molded as one piece with the mask. The cap would be flexible enough and of proper shape and dimension to allow the bridge band with holes to slide over the cap, but would be unable to slide back off the posts.

A final example is solely chemical, where the bridge band would simply be bonded to the surface of the mask.

Prior art has shown that it is possible and usual for bridge bands to become detached from the mask, which relinquishes the seal and security of the mask around the nose area of the user.

### SUMMARY OF THE INVENTION

The present invention is directed to an oxygen mask for interfacing a user to the source of a gas with a bridge band to secure and/or seal the mask to the users' face. A head strap or headgear will secure the mask, generally, to the user's face in conjunction with a bridge band.

Said bridge band will be constructed out of a material that is flexible, but also will have memory. Materials could include soft metals like aluminum or polymers with similar properties.

The size of the bridge band will differ based on the size of the mask or intended user; however, it should be long enough to accomplish its intended purpose of securing and/or sealing the mask to the bridge area of the user's nose, but short enough to avoid excess material that would prevent its performance. The width and thickness of the band will also be a determining factor in its performance, and thus, should be of appropriate size to accomplish a secure fit and/or seal to the bridge area of the user's nose.

The present invention has a particular shape that cooperates with the mask to provide a secure attachment between the two components. Towards the ends of the bridge band are recesses on either side that engage into openings located in the nose area of the mask. The openings in the mask are produced by features within the molding process or by cutting the material after the molding process. The mask has a pair of these openings on each side of the mask's centerline. The pair of openings is spaced to the approximate length of the recesses of the bridge band. In addition, the two pairs are spaced to the approximate length between the recesses of the bridge band. The length of the openings is approximate to the width of the bridge band at the recesses.

The present invention is assembled by lacing one end of the bridge band into the first opening, and then through the second opening on one side of the mask. Accordingly, the bridge band is laced through the openings on the second side of the mask. At this point the bridge band recesses will be engaged into the openings of the mask. In this manner the present invention will be more secure than the prior art because the possibility of failure of a chemical or mechanical bond will be removed.

### BRIEF DESCRIPTION OF THE DRAWINGS

FIG. 1 is a close-up perspective view of the bridge band with recesses towards the ends and on each side.

FIG. 2 is a side view of an oxygen mask with a pair of openings intended to accept the bridge band.

FIG. 3 is a front view of an oxygen mask with two pair of openings on each side of the centerline.

FIG. 4 is a close-up perspective of the method in which a bridge band is laced through the openings of a mask.

FIG. 5 is a front view of a mask with the bridge band properly laced through both pairs of openings in the mask.

FIG. 6 is a side view of a mask with bridge band fitted to a face in the proper fashion.

### DETAILED DESCRIPTION OF THE INVENTION

In the following description, terms such as horizontal, upright, vertical above, below, beneath and the like are used solely for the purpose of clarity in illustrating the invention and should not be taken as words of limitation. The drawings are for the purpose of illustrating the invention and are not intended to be to scale.

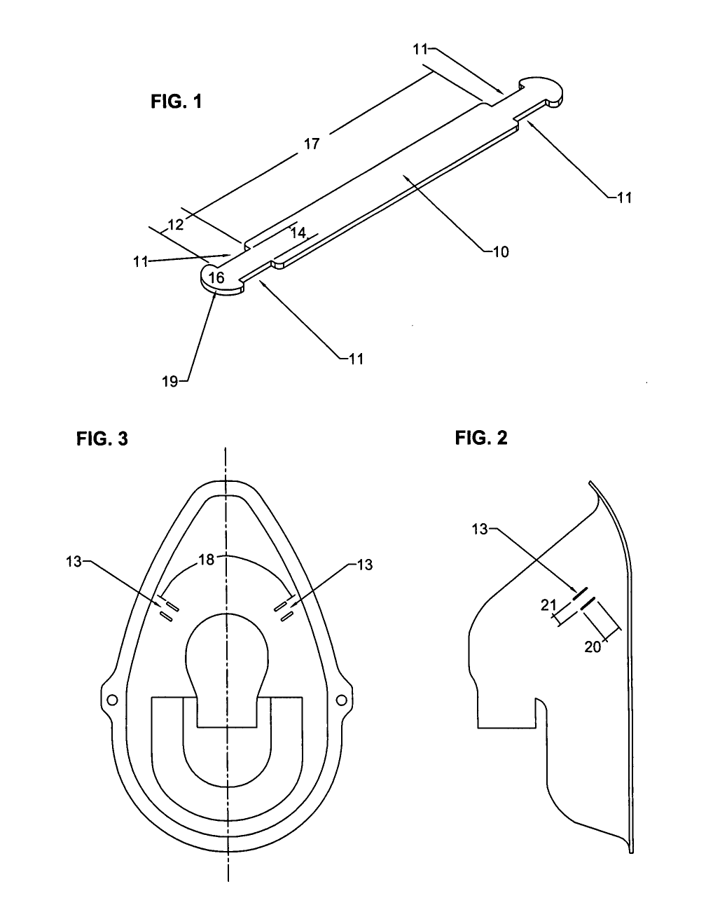

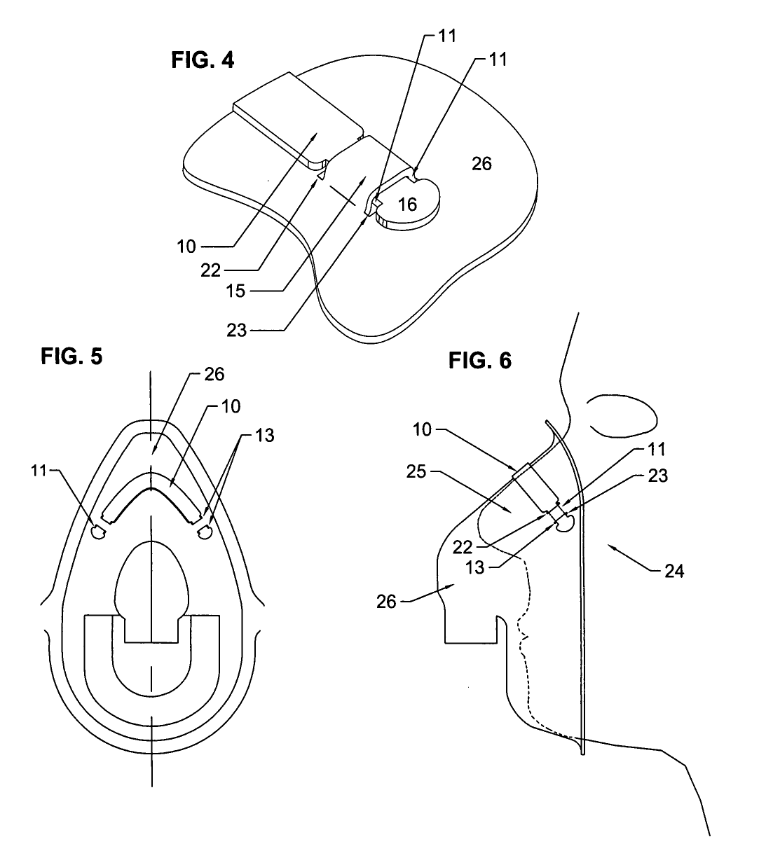

Referring to the drawings and first to FIG. 1, a bridge band 10 comprising of four recesses 11. The recesses 11 are located towards the ends of the bridge band and are on both sides of the bridge band, making it symmetrical. The recesses' length 12 is such that it can be fully engaged into the openings 13 of FIG. 2. FIG. 4 shows the full engagement between the bridge band and the openings. The width 14 of FIG. 1 created by the opposing recesses is such that a flat barb 16 is created at each end of the bridge band. The distance 17 between the recesses of each end is such that the bridge band will span the contoured distance 18 of FIG. 3 between the openings 13. The curved ends 19 of FIG. 1 aid in the lacing of the bridge band through openings.

Referring now to FIG. 2, the side view of a mask, the openings 13 have a length 20 such that it allows the barb 16 of FIG. 1 to slide through, but also retains the bridge band by encompassing the recesses 11. The distance 21 of FIG. 2 between the openings is such that the recesses 11 of FIG. 1 can be fully engaged.

Now referring to FIG. 4 to explain the assembly of the bridge band to the mask. The barb 16 is inserted into the first opening 22 and then out of the second opening 23. At this point the loop 15 will be fully engaged around the recesses 11. The way the barb is shaped will not allow the bridge band 10 to be accidentally removed from the mask 26. The opposite end of the bridge band is then inserted through the openings on the opposite side of the mask.

The final assembly of the bridge band to the mask is seen in FIG. 5. The bridge band 10 conforms to the contours of the nose area of the mask. Subsequently, the bridge band and mask 26 conforms to the user's nose when the bridge band is pressed to conform around the user's nose.

FIG. 6 shows the mask and bridge band fitted to a user 24. The bridge band 10 is pressed around the nose 25 so that it conforms to the contours of the nose. Based on the memory of the material used in the manufacturing of the bridge band, it will remain conformed to the nose creating a secure fit and/or tight seal about the user's face.

1. The method by which a bridge band attaches to an interface designed to communicate breathing gases to a user wherein the bridge band laces into then out of openings in the nose area of the interface.

2. The method of claim 1, wherein said bridge band contains two opposing recesses towards each end of the bridge band, which creates a neck area.

3. The method of claim 1, wherein said openings are four in number, with two that are parallel on each side of the centerline of the interface.

4. The method of claim 1, wherein said recesses of claim 2 and said openings of claim 3 are sized such that they engage fully and tightly so that once assembled together, the two will not accidentally separate.
